(19) United States
(12) Patent Application Publication
(10) Pub. No.: US 2024/0423404 A1
(43) Pub. Date: Dec. 26, 2024

(54) PARCEL STORAGE BOX AND RELATED KIT AND SYSTEM

(71) Applicant: Kaddy Box Holdings Ltd, Bicester (GB)

(72) Inventor: John Archie Kevill, Bicester (GB)

(21) Appl. No.: 18/694,030

(22) PCT Filed: Sep. 28, 2022
(86) PCT No.: PCT/GB2022/052449

§ 371 Date: Mar. 21, 2024

(30) Foreign Application Priority Data
Sep. 29, 2021 (GB) 2113916.7

(51) Int. Cl. A47G 29/20; A47G 29/14; A47G 29/16; A47G 29/30; B65D 6/00; B65D 43/16; B65D 55/14; B65D 81/02; G06Q 10/0836

(52) U.S. Cl. CPC A47G 29/20; A47G 29/141; A47G 29/16; A47G 29/30; B65D 11/20; B65D 43/163; B65D 55/14; B65D 81/022; G06Q 10/0836; A47G 2029/148; B65D 2255/00; B65D 2313/00; B65D 2543/00194

(57) ABSTRACT

A parcel storage box for storing one or more parcels, the box including a housing having a base, one or more sides and a top, at least some of which are connected together by snap-fit connections, and including a parcel storage chamber, a parcel entrance in the housing for allowing a parcel having dimensions of at least 8 cm×8 cm×8 cm to be introduced into the parcel storage chamber, and a lockable parcel exit in the housing. The box can include one or more barrier members connected to the housing to form a barrier across at least part of the parcel entrance to obstruct parcel removal through the parcel entrance. The barrier members can be moveable or deformable into the parcel storage chamber for admitting a parcel into the parcel storage chamber and configured to substantially re-form the barrier across the parcel entrance after admitting a parcel.

The present invention relates to a parcel storage box for storing one or more parcels, particularly but not exclusively when a person is not present to take delivery of the one or more parcels.

### BACKGROUND TO THE INVENTION

Parcel delivery is frequently used when goods are purchased, to convey the purchased goods to the purchaser. A parcel courier is normally engaged to deliver one or more parcels to the stated delivery address for receipt by a person at that address.

It is often the case that the expected time of delivery is quite uncertain, with periods of 2 hours, 4 hours or even 8 hours (e.g. 9am to 5pm) given as a potential window within which delivery will be attempted. This is highly inconvenient, particularly when the delivery is made at the end of the notified window. Furthermore, the delivery window can be changed during the day, making it difficult to properly schedule other activities on the day of delivery.

If there is no one available to take delivery of the parcel(s) straightaway, then there are various scenarios which can occur. Sometimes there is a nominated space, perhaps out of sight behind a gate, where the courier may have instructions to leave the parcel(s) in the event that there is no one in to take delivery. In other cases, the courier may take it upon themselves to find a safe space at the property. Either way, the goods in the parcel(s) may be damaged by adverse weather if left outside.

Furthermore, there must be easy access to the nominated space to allow the delivery person to access to leave the parcel(s) there. This means that the parcel(s) are then at risk of being subsequently stolen in the time until the addressee can collect them.

Sometimes the parcel(s) will be returned to the sender, and usually a note is posted through the letterbox with details of how to collect it from a depot or rearrange delivery, which is a safer approach but generally inconvenient. In some instances, the parcel(s) of goods will be left with a neighbour, which can sometimes lead to goods going missing or being difficult to track down (if the courier did not leave a note with details of which neighbour took delivery). The courier may even leave the goods on the doorstep, leaving them in clear view and at higher risk of opportunistic theft.

Sometimes a parcel courier may reschedule a delivery in the event that someone is not present to sign for the parcel when attempting to deliver a parcel. However, re- scheduling a delivery results in additional costs and also increases the carbon footprint of the delivery due to additional fuel/energy use. When scaled up across the millions of deliveries made each year, the environmental impact of rescheduled parcel deliveries is substantial, in addition to the time loss involved in attempting signed-for delivery (both on the first and subsequent occasion(s)).

It is an object of the present invention to reduce or substantially obviate the aforementioned problems.

### STATEMENT OF INVENTION

According to a first aspect of the present invention, there is provided a parcel storage box for storing one or more parcels, the box comprising
a housing including a parcel storage chamber,
a parcel entrance in the housing for allowing a parcel having dimensions of at least 8 cm×8 cm×8 cm to be introduced into the parcel storage chamber, and a lockable parcel exit in the housing for allowing the parcel to be retrieved from the parcel storage chamber,
in which one or more barrier members are connected to the housing and form a barrier across at least part of the parcel entrance to in use substantially obstruct parcel removal through the parcel entrance,
the one or more barrier members being moveable or deformable into the parcel storage chamber for admitting a parcel into the parcel storage chamber, and the barrier members being configured to substantially re-form the barrier across the parcel entrance after admitting a parcel.

The parcel storage box provides a convenient balance between increased parcel security and ease of access for delivery purposes. A delivery person can readily drop off a parcel inside the storage box, whether or not a person is at the delivery address to take receipt, and the parcel is not left in view of any opportunistic thief that may pass by in the time between delivery and parcel retrieval by the addressee. The barrier member(s) across the parcel entrance provide a one-way barrier system which substantially prevents a thief pulling a parcel out of the storage box through the parcel entrance.

The parcel storage box substantially mitigates the need to track down a parcel left with a neighbour or returned to a delivery depot, or alternatively to go through the rigmarole of claiming that a parcel has been lost by a delivery company and obtaining compensation or replacement item(s). It is also comparatively safer than a conventional designated ‘safe space’, which may be out-of-sight but presents no obstacle to parcel theft, unlike the present invention.

An analogy can be made to bicycle locking devices. A determined thief is usually able to steal a bike despite the presence of a securing chain and/or D-lock. However, the presence of the lock and chain are often sufficient to deter theft. In the present case, the parcel storage box allows a parcel to lie out of sight, and that is often sufficient to mitigate theft because many instances of parcel theft are opportunistic.

A parcel is considered to be a container, typically a cardboard box, in which one or more goods are contained. The goods are typically too large to fit through a conventional letter box slot or fit into a mailbox. The term parcel is not intended to describe a particular type of package or material, or even that a particular delivery must be contained in packaging. A parcel is an object or item intended for delivery to a person, often at the address where the parcel storage box is installed.

An envelope is considered to be distinct from a parcel, since an envelope is typically thin in its third dimension (thickness on the order of millimetres). The vast majority of envelopes contain a letter or other paper documents. An envelope does not normally contain goods other than very small items, e.g. screws, USB sticks, cosmetic items, which the envelope is flexible enough to contain. Any larger item needs to be delivered in a parcel.

Note that the minimum parcel dimensions of 8 cm³ are intended to represent dimensions of 8 cm when measured along substantially orthogonal axes.

The parcel entrance and the parcel exit are intended to be different features of the parcel storage box. That is, the two are distinct features and should not be provided at a common point nor should they overlap each other.

The parcel entrance may have a minimum width of about 8 cm. The parcel entrance may have a minimum height (or length) of about 8 cm. These dimensions are intended to be interpreted as the 2D dimensions when looking down on the parcel entrance from above.

The parcel entrance may be provided in an upper portion or top side of the parcel storage box. Where the parcel entrance is in the top side, the barrier may be in a substantially horizontal plane relative to a sidewall of the housing. Parcels can be deposited through the upper end of the housing, leaving the parcel entrance unobstructed for receiving any additional parcels.

The parcel entrance may extend across a width substantially corresponding to the entire width of the parcel storage box (or chamber thereof). This may be across the top of the box.

A portion of each barrier member may extend across the full width or full height of the parcel entrance. That is, a longest dimension of each barrier member may substantially match the full width or height of the parcel entrance that barrier member is adjacent to.

There may be a plurality of barrier members which may be moveable or deformable into the parcel storage chamber. For example, some or all of the barrier members may deflect downwards into the chamber when a parcel is dropped or pushed through the parcel entrance.

The barrier members may not be hinged at the point or region where they are connected to the box. That is, portions of the barrier members towards the middle of the parcel entrance may be moveable or deformable into the parcel storage chamber, whilst portions of the barrier members at a perimeter of the parcel entrance remain substantially in position relative to the parcel entrance (or otherwise move/deform to a lesser extent) during admittance of a parcel. In other words, each barrier member may not pivot in its entirety when admitting a parcel into the parcel chamber.

The barrier (or barrier members) may be in an unlocked state. That is, there may be no lock associated with the barrier or barrier members, or the parcel entrance. This simplifies parcel drop-off for a delivery person because they can deposit the parcel in the storage box without first having to contend with a lock.

A tether may be provided for connecting the barrier member to the housing. The tether may be connected at one end to the barrier member (e.g. to an underside of the barrier member) and at the other end to the housing. The tether may connect to a distal portion of the barrier member. The tether may connect to an inner surface of the housing. A tether may be provided on each barrier member, or a subset of the barrier members. The or each tether may be substantially inextensible.

The tether(s) allow inward movement or deformation of the barrier member(s), but substantial resist outward movement of the barrier member(s) such as during attempted parcel theft via the parcel entrance.

The plurality of barrier members may be configured to substantially resist movement or deformation in a direction away from the parcel storage chamber. For example, if a would-be thief was to reach through the parcel entrance and attempt to pull a parcel back through the parcel entrance and out of the storage box, then the barrier members would impede (and, in most scenarios, prevent) removal of the parcel.

For example, the barrier members may interlock or engage one or more of the other barrier members in a way that prevents or inhibits outward movement of the member(s) away from the storage chamber.

There may be at least four barrier members which are arranged across the parcel entrance. Each barrier member may be substantially triangular or wedge-shaped (or both). Each barrier member may have a base side arranged along a side of the parcel entrance and an apex arranged in a central region of the parcel entrance. The base side or a lateral/rear side of the barrier member may be connected to the side of the parcel entrance or part of the housing adjacent thereto.

The number of barrier members may correspond to the number of sides present in the two-dimensional shape of the parcel entrance, when viewed from above. For example, a four-sided parcel entrance (e.g. square or rectangular) may have four barrier members. In another example, a six-sided parcel entrance (e.g. regular hexagonal) may have six barrier members. In another example, an eight-sided parcel entrance (e.g. regular octagonal) may have eight barrier members.

Where the two-dimensional shape of the parcel entrance has a plurality of sides, there may be a single barrier member per side or a plurality of barrier members per side (or a mixture where some sides have multiple barrier members but some sides have a single barrier member).

Each barrier member may have a triangular-shaped profile when viewed from above. The barrier members may include members having one of a first triangular-shaped profile and a different second triangular-shaped profile.

A wedge-shaped barrier member may be thinner towards the middle of the parcel entrance, i.e. the apex of the barrier member. Attempted retrieval of a large parcel causes the parcel to abut the barrier member at a region further away from the middle of the parcel entrance, which makes it harder to retrieve a parcel the larger it is (although it is still extremely difficult to attempt retrieval of even a small parcel).

The barrier formed by the members may be substantially planar. The barrier members may be arranged in a common plane. Respective uppermost portions of each barrier member may lie at substantially the same heights. Respective lowermost portions of each barrier member may lie at substantially the same heights. The terms uppermost and lowermost are used to describe the scenario where the parcel entrance and barrier members are provided in the top of the parcel storage box, but may also be construed as meaning outermost and innermost (with respect to the box as a whole).

When admitting a parcel, some or all of the barrier members may temporarily deform or bend into a non-planar configuration.

Each barrier member may border or abut adjacent barrier members at its lateral sides.

Each barrier member may not overlap with or overlie another barrier member.

The parcel storage box may include pairs of opposing barrier members.

A first opposing barrier member may be disposed directly opposite a second opposing barrier member. That is, there may be no lateral offset between opposing barrier members.

The first opposing barrier may be disposed at a position of the parcel entrance which is 180 degrees opposite to the second opposing barrier member, with respect to a perimeter of the parcel entrance.

Opposing free ends or apices of opposing barrier members may meet in a middle region of the parcel entrance.

The barrier members together may substantially cover the whole area of the parcel entrance. This helps block the view of the chamber and prevent a person from seeing the parcels already located in the chamber.

Apices of the barrier members can converge at a middle of the parcel entrance. This makes it easier for the barrier members to deform or move when accepting a parcel into the chamber via the parcel entrance.

Each barrier member may slope inwardly from a peripheral edge of the parcel entrance to the middle of the parcel entrance. For example, in the case where the parcel entrance is on top of the housing, the middle of the barrier (e.g. an apex of the barrier member) may be disposed at a vertical position which is lower than a top edge of that barrier member.

Each barrier member may slope downwardly from a peripheral edge of the parcel entrance in a direction towards the base of the parcel storage box.

Each barrier member may be made of rubber or flexible polymer, or another elastomeric material.

This allows the members to flex or deflect into the chamber to accept an inbound parcel. In the event of attempted parcel retrieval via the parcel entrance, the rubber or polymer barrier members are configured to flex or deform in a way that does not provide a suitable aperture for the parcel to pass through.

The barrier members may not extend into the parcel storage chamber until, during use, a parcel is pushed against the barrier members. Apices of the barrier members (or portions of the barrier members disposed adjacent to a central longitudinal axis of the parcel storage box) may be disposed substantially in a plane of the parcel entrance.

The rubber members also have a relatively high coefficient of friction when in abutment, making it difficult for them to slide relative to each other. It will be appreciated that other suitable materials other than rubber may be selected.

The parcel exit may be in a side of the housing. The parcel exit may include a door and a key-operated lock. This substantially prevents unauthorised retrieval of any parcel(s) in the storage box.

A cover or lid is provided over the parcel entrance and the one or more barrier members. The cover or lid may be hinged to the housing. One or more magnets may be provided in the cover or lid. One or more corresponding magnets may be provided adjacent to the parcel entrance for holding the cover or lid in a closed position.

The cover or lid substantially prevents water from entering the parcel storage chamber, which may damage the parcel contents. The cover or lid also mitigates UV-degradation of the barrier member(s). The magnet(s) help to hold the lid shut to substantially prevent it from blowing open in the wind, although the lid is still relatively easy to open by hand when necessary.

A slot may be provided in the housing for accepting a letter or thin parcel into the parcel storage chamber.

A ledge may be provided adjacent to the slot. The ledge may inside the housing or chamber. The ledge may be disposed adjacent to a lower side of the slot. The ledge may be connected to or integrally formed with the panel at the front of the housing.

The ledge minimises water ingress into the chamber, e.g. due to rain, and also makes it harder for a would-be thief to attempt to reach down into the chamber via the slot.

In various aspects of the invention, the housing may comprise a base, one or more sides and a top. Some or all of the base, side(s) and top may be connected together by snap-fit connections.

In this first aspect of the invention, the housing comprises a base, one or more sides and a top, at least some of which are connected together by snap-fit connections.

The base may have snap-fit connections to the one or more sides. The snap-fit connections may be provided at sides and/or corners of the base.

The top may have snap-fit connections to the one or more sides. The snap-fit connections may be provided at sides and/or corners of the top.

Providing snap-fit connections makes assembly of the storage box facile. Snap-fit connections are comparatively tamper-resistant, so it also makes it harder to break into because disassembly is difficult.

The housing may be at least about 1 m in height. The housing may be at least about 1.25 m or 1.5 m in height. Having a taller storage box increases the depth of the chamber, which makes it correspondingly harder to reach into the chamber to take hold of a parcel for attempted retrieval. However, the parcel storage box may not exceed about 2 m in height, because this makes initial delivery of a parcel difficult.

The housing may comprise a plurality of panels. The housing may comprise a plurality of corner members. The plurality of corner members may be connected to the plurality of panels.

The housing may comprise a plurality of metal panels. The metal is preferably a rust-resistant metal such as steel or stainless steel. The housing may comprise a plurality of plastic members. The base of the housing may be made of plastic. The corners of the housing may be made of plastic.

The metal panels are robust to resist attempted forced entry. The plastic members can be formed to connect to the panels, e.g. with snap-fit connections or to accept a panel via a slot. The plastic should also be robust enough to resist attempted forced entry.

A base wall of the parcel storage chamber may comprise a cushioning material. For example, the base of the parcel storage chamber may include foam such as EPS foam.

This helps to mitigate potential damage to the contents of a parcel, if dropped into the storage chamber from a height. For example, a parcel may fall between about 25 cm and 1.5 m when released from the grip of a delivery person. The cushioning material is an impact absorbing material that can reduce a peak force experienced by an object within the parcel, thereby minimising the risk that it breaks on impact with the base of the parcel storage chamber.

The parcel storage chamber may be substantially empty or vacant. That is, besides any parcels that may be provided within the chamber or the deflection of the barrier members into the chamber during use, the volume of the parcel storage chamber may be substantially void of other features of the parcel storage box. Put another way, the space between the base (or, where provided, the top of the cushioning material at the base) and the parcel entrance may be substantially free of obstructions.

The parcel storage box may be floor-standing. The parcel storage box may be wall-mounted.

The housing may include one or more floor-fixing connection points. A side of the housing may include one or more wall-fixing connection points.

This allows the user to secure the parcel storage box to an adjacent wall or pavement or patio (or both) for security purposes.

Other forms of mounting points are also envisaged. For example, the parcel storage box may include cable-receiving means (such as handles or slots) for one or more cables to fit through. Preferably the cable(s) are metal or made of a combination of materials such as metal and plastic. This allows the box to be secured to a post or pillar such as a lamppost, for example, when the cable(s) are fitted and tightened.

One or more sensors may be provided for detecting one or more parcels delivered into the parcel storage chamber. For example, a load sensor may be provided for detecting a load on the base wall of the parcel storage chamber. A motion sensor may be provided to detect motion within the parcel storage chamber for detecting movement of a parcel therein. A reed switch or similar type of switch may be provided on or adjacent to the barrier members for detecting movement or deformation of the barrier members into the parcel chamber. Where a lid or cover is provided (typically hinged to the housing), a switch may be provided to detect lid/cover opening, which is generally indicative of an imminent parcel delivery. For example, the switch may be in or next to the hinge of the lid/cover.

The sensor may include a load sensor or a weight sensor. The sensor may be configured to detect a load on a base wall of the parcel storage chamber. An alarm may be connected to the load sensor or weight sensor. The alarm may be a battery-powered alarm, for example.

In use, the alarm may be primed when the load sensor or weight sensor detects a parcel has been placed in the chamber. That is, when load on the base wall increases, the alarm is set based on the change in sensor output, which indicates that a parcel is present.

The alarm may be configured to issue an output (e.g. sound an alarm such as a bell) when the load or weight sensed by the sensor is reduced, i.e. when the parcel leaves the base wall. If the door is open or unlocked (e.g. prior to the parcel being removed from the base wall), then the alarm may be suppressed or deactivated.

Sensor output(s) from the sensor(s) may be used to trigger a digital notification or alarm/alert for a person (preferably the addressee of the parcel). For example, an output from a load sensor may correspond to an item or parcel weight, and this may be used to determine the identity (or potential identity) of an item which has been left in the box.

The alarm/alert may indicate an instance of attempted theft, for example, if the load or weight sensor detects a reduction in load when the parcel exit is locked.

In another example, a sensor output may be used to trigger an electronic doorbell or smart doorbell. The trigger may result in a custom doorbell tone, message or tune for corresponding to a parcel delivery notification. This means that if a person is present at a delivery address and the delivery person has left the parcel in the storage box without knocking on the door or ringing the bell, the person at the address is prompted to check the storage box.

Communication means may be provided which is configured to send a signal to an electronic device, such as a smartphone, for notifying a user when the sensor detects parcel delivery.

The sensor(s) allow the parcel storage box to log when a parcel has been delivered. Where communication means is provided, a user can remotely monitor when a parcel has been delivered. The box may send a ‘push’ notification, e.g. to the user's smartphone or tablet computer. The user may be able to electronically request information from the box for determining if a parcel is present.

A machine-readable label or code, such as a QR code, may be provided on the housing for scanning by an electronic device of a delivery person. For example, the machine-readable label or code may be provided on a surface of the hinged cover or lid, such as an outside surface, or on an underside surface when the lid/cover is in a closed configuration over the parcel entrance. The label or code may be provided on the door, such as the outside face of the door.

This allows the delivery person to check that they are delivering the parcel into the correct storage box. That is, the QR code may provide a measure which contributes to proof of delivery address. In some embodiments, the label or code can be quickly checked against a database of storage box identifiers and corresponding delivery addresses to confirm whether or not the box corresponds to the address on the parcel(s) being delivered. This is useful where there are multiple storage boxes at the same location, e.g. in a block of apartments or other shared accommodation structures (such as a building).

An electronic lock may be provided to lock the door against opening. Input means such as a keypad may be provided for unlocking the electronic lock to allow a parcel to be removed from the box.

The electronic lock may be unlockable via an electronic code. The electronic code may be obtained by the delivery person via an electronic device or scanner.

For example, where the machine-readable label or code is provided on an accessible region of the box (typically housing top, front or side, or on the hinged lid/cover), then the delivery person may be able to scan that label or code and receive an access code in return. This is useful in an intra-company system, for example, if a delivery company uses a parcel storage box for temporary parcel storage where the parcel dropped off by one delivery person and collected by another delivery person.

In some embodiments, the access code may be automatically sent to the storage box, or it may be sent to the delivery person's device and broadcast or forwarded to the electronic lock. That is, the delivery person may not need to manually enter an access code to deactivate the electronic lock.

The machine-readable label or code may, where provided, correspond to or be usable to generate an input code for use in unlocking the electronic lock. That is, the access code may be generated substantially at the time that the code is scanned, i.e. at the time of the request for access.

The electronic lock may include a locking bar or similar, and an actuator configured to move the locking bar (or equivalent) from a locked position to an unlocked position which allows parcel entry through the parcel entrance.

The electronic lock may be configured to return to a locked configuration following unlocking, preferably re-locking automatically. For example, the lock may re-lock after a predetermined period of time has passed since it was initially unlocked, or since parcel entry into the chamber was detected. The lock may re-lock when the door is returned to a closed position.

A camera or camera system may be provided as part of the parcel storage box. The camera system may be configured to record and/or transmit one or more images of the region in front of the parcel storage box, although it will be appreciated that the camera may be provided on any suitable side of the box (or multiple cameras may be provided). A suitable data storage device may be connected to the camera or system for recording images and/or video from the camera(s).

A user can remotely monitor the camera feed from the camera(s) of the storage box for security purposes.

A suitable power source such as a battery may be provided for powering electronic components of the storage box. The power source may be disposed in a base or rear wall of the storage box, for example.

A plurality of parcel storage boxes may be provided adjacent to each other, e.g. in an arrangement suitable for a block of flats or another shared accommodation building.

It is envisaged that there are some embodiments where a single housing may be used to accommodate the multiple parcel entrances, chambers and exits. For example, there may be a plurality of parcel entrances with corresponding barriers, a plurality of parcel storage chambers, and a plurality of parcel exits in one parcel storage box or device. A dividing wall may be provided between the adjacent chambers for keeping each chamber separate.

The parcel storage device may therefore store parcels intended for multiple addresses, for example.

The parcel storage box or device may be modular to enable multiple boxes/devices to be connected together in a modular fashion. This allows the number of boxes to be easily increased/reduced as needed, and allows the boxes to be secured to each other, e.g. back to back, if desired.

According to a second aspect of the invention, there is provided a kit for construction into a parcel storage box for storing one or more parcels, the kit comprising
a base, one or more side panels or sides for connection to the base, and a top for connection to the one or more side panels or sides, which are configured for assembly into a housing that includes a parcel storage chamber and a parcel entrance for allowing a parcel having dimensions of at least 8 cm×8 cm×8 cm to be introduced into the parcel storage chamber, in which at least some of the base, side panels or sides, and top are connectable together by snap-fit connections, and
a lockable parcel exit in or connectable to one of the side panels or sides for allowing the parcel to be retrieved from the parcel storage chamber,
one or more barrier members which are connectable to the housing to form a barrier across at least part of the parcel entrance to in use substantially obstruct parcel removal through the parcel entrance,
when connected to the housing, some or all of the barrier members being moveable or deformable into the parcel storage chamber for admitting a parcel into the parcel storage chamber, and the barrier members being configured to substantially re-form the barrier across the parcel entrance after admitting a parcel.

Providing a kit is highly advantageous for ease of delivery. In particular, the kit may be a flat pack kit of the elements of the parcel storage box.

The advantages of the kit, when constructed into a parcel storage box, are substantially similar to those presented above for the first aspect of the invention.

Any features presented with respect to the first aspect of the invention may be provided in any combination with respect to the second aspect of the invention.

According to a third aspect of the invention, there is provided a parcel delivery system for delivering a plurality of parcels to a plurality of locations, the system comprising
a plurality of parcel storage boxes at a plurality of addresses, each parcel storage box according to the first aspect or being constructed from a kit according to the second aspect, in which
each parcel in the plurality of parcels to be delivered is addressed to an address which is one of the plurality of addresses,
a delivery route for delivering the plurality of parcels includes only stops at addresses which are comprised in the plurality of addresses.

This allows for an optimum parcel delivery route where the parcel courier knows that they do not need to spend time attempting to deliver the parcel directly to a person at the relevant address, or finding a safe space to leave the parcel, or attempting to leave the parcel with a neighbour. This substantially streamlines the parcel delivery process.

According to another aspect of the invention, there is provided a parcel delivery system for delivering a plurality of parcels to a plurality of locations, the system comprising
a plurality of parcel storage boxes distributed over a geographical area, each parcel storage box according to the first aspect or being constructed from a kit according to the second aspect, in which
in a first subset of the parcel storage boxes, each parcel storage box is a way station at an intermediary location for receiving one or more parcels in transit for delivery at one or more subsequent destinations, and
in a second subset of the parcel storage boxes, each parcel storage box is located at a given destination for at least one of the parcels being delivered.

This provides a network of parcel storage boxes distributed over a district, town, city or region, depending on the number of parcel storage boxes and the distance between them. Some of the boxes are located at termini, i.e. destination points for particular parcels, and some of the boxes are way stations (or drop-off points) in the sense that at least some of the parcels which are deposited in those boxes have not yet been delivered to the address on that parcel.

Providing a network of parcel storage boxes facilitates more efficient parcel delivery by allowing parcel drop-off and pick-up without necessarily returning to a central depot. Decision mathematics or another shortest-path planning system may be used to plan more efficient parcel delivery routes which minimise distance travelled (and fuel/battery energy used) and time spent in queuing traffic, for example.

The system may enable delivery routes which have some parcel delivery vehicles return to a central depot whilst others may travel between the way stations, depending on what is considered to be most logistically efficient.

For parcel storage boxes with parcel sensors, delivery routes may be planned or updated to account for storage boxes which are full or closer to full than other storage boxes.

According to another aspect of the invention, there is provided a parcel storage box as set out in claim 30. The parcel storage box may include any feature or combination of features presented with respect to the first aspect of the invention.

According to another aspect of the invention, there is provided a kit as set out in claim 31. The kit may include any feature or combination of features presented with respect to the first aspect of the invention.

### BRIEF DESCRIPTION OF THE DRAWINGS

For a better understanding of the present invention, and to show more clearly how it may be carried into effect, reference will now be made by way of example only to the accompanying drawings, in which:

FIG. 1 shows a perspective view of a parcel storage box;

FIG. 2 shows a perspective view of the parcel storage box of FIG. 1 with the lid and door open;

FIG. 3 shows a top of the parcel storage box of FIG. 1 with the lid open;

FIG. 4 shows a partial front cross-sectional view of the parcel storage box of FIG. 3;

FIG. 5 shows a partial front cross-sectional view of a lower portion of the parcel storage box of FIG. 3;

FIG. 6 shows an underside perspective view of the parcel storage box of FIG. 2;

FIG. 7 shows a perspective view of a parcel storage box of FIG. 1 with the door open;

FIG. 8 shows a first perspective view of a barrier member of the parcel storage box of FIG. 1;

FIG. 9 shows a second perspective view of the barrier member of FIG. 8;

FIG. 10 shows a perspective view of a parcel entrance and snap-fit mechanism for a corner member of the parcel storage box;

FIG. 11 shows a perspective view of part of the parcel entrance of FIG. 10;

FIG. 12 shows an exploded side view of the parcel entrance of FIG. 10;

FIG. 13 shows a rear perspective view of the parcel storage box of FIG. 1;

FIG. 14 shows a front cross-sectional view of parcel storage box of FIG. 3 during use, when admitting a parcel;

FIG. 15 shows a front cross-sectional view of parcel storage box of FIG. 14, during attempted removal of the parcel;

FIGS. 16a to 16e show a series of perspective views of side panels of a kit of a parcel storage box being connected together, including a partial enlarged perspective view of part of FIG. 16a; and

FIGS. 17a and 17b show perspective views of connection of a base and a top to the assembled side panels of FIG. 16e, including two partial enlarged perspective views of parts of FIG. 17a, for constructing the parcel storage box.

### DESCRIPTION OF PREFERRED EMBODIMENTS

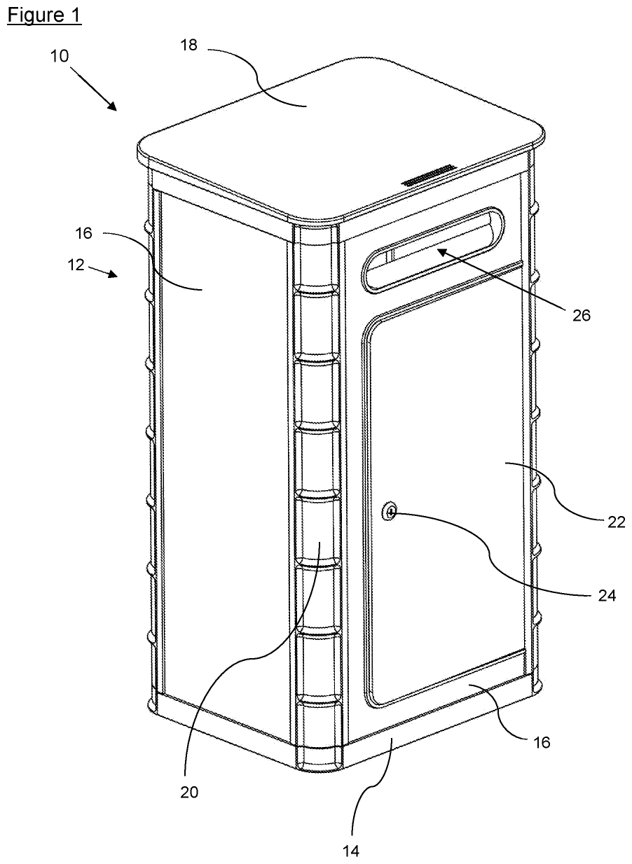

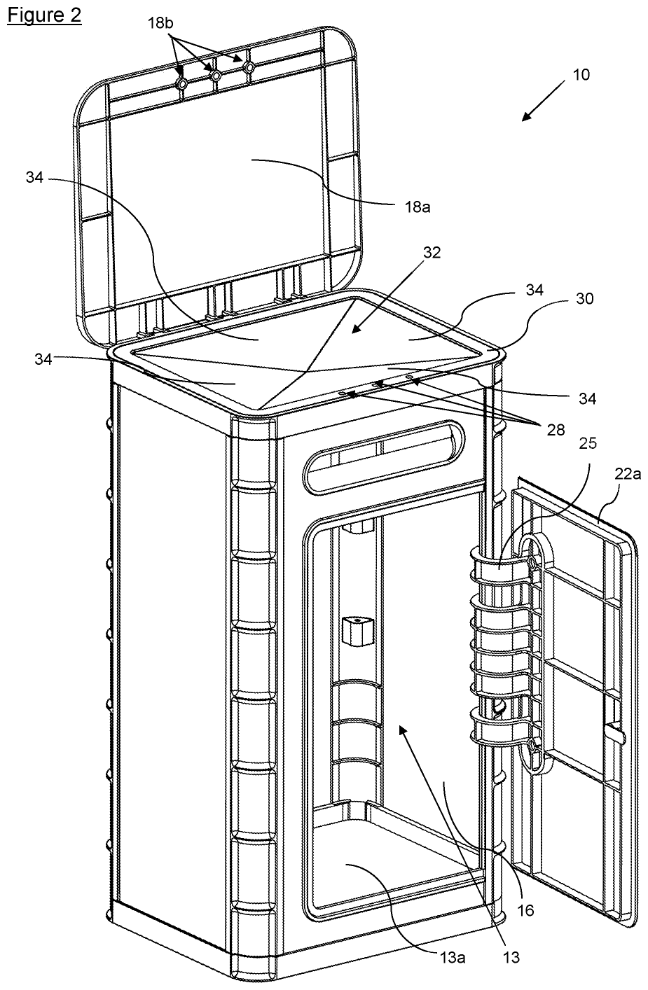

FIGS. 1 and 2 shows an embodiment of a parcel storage box, indicated generally at 10. The box 10 is an upright pillar-type box in this embodiment. The box 10 is able to contain a plurality of parcels and keeps them out of sight of passers-by. For example, the box 10 may be positioned outside a house or provided in a porch.

The box 10 includes a housing (indicated generally at 12). The housing 12 is substantially cuboidal in this embodiment. The housing 12 defines a parcel storage chamber, indicated generally at 13 (FIG. 2). The housing 12 has approximate dimensions of 72 cm×40 cm×32 cm in this embodiment. However, the dimension of the housing may vary in other embodiments.

The housing includes a base 14, four side panels 16, and a top which includes a lid 18. In this embodiment, the base 14 is plastic. The side panels are made of metal, which in this embodiment is stainless steel (although it will be appreciated that another suitable metal or another material may be used).

The top includes a hinged lid 18 in this embodiment. The lid 18 is made of plastic. The lid 18 is in a closed position in FIG. 1, and an open position in FIG. 2. The lid 18 in this embodiment is not locked against opening, although in other embodiments a locking means may be provided.

Corner members 20 are provided between neighbouring pairs of the side panels 16. In this embodiment, the corner members 20 and side panels 16 are adapted to have snap-fit connections, but it will be appreciated that any suitable connection means may be provided in other embodiments, e.g. screw fixings.

The side panel 16 at the front of the storage box 10 includes a door 22. The door 22 provides a parcel ‘exit’, that is an access for retrieving a parcel held within the box 10. The door 22 is in a closed position in FIG. 1 and shown in an open position in FIG. 2. The door includes a key lock 24 (e.g. a CAM key lock), with a bar for preventing door opening whilst it is locked. It will be appreciated that any suitable locking means or mechanism like an electronically-operated lock may be used in other embodiments. The door 22 may be provided in one of the other side panels 16, instead of the front panel.

A seal or gasket 22a is provided around a peripheral inner edge of the door 22. In some embodiments, the seal can instead be provided on the housing 12 where the door meets the housing 12. This substantially prevents water from passing around the door 22 and into the chamber 13.

The door hinge 25 can be seen in FIG. 2. The hinge 25 has a plurality of C-shaped members in this embodiment, which permit the door to hinge about the adjacent corner member 20. The hinge 25 can be made of plastic, for example, and is secured to the back of the door 22 by a hinge plate joined to the C-shaped members.

A letter slot 26 is provided through an upper end of the front panel 16. The letter slot 26 is arranged horizontally in this embodiment, but it will be appreciated that a vertical slot or angled slot could be provided in other embodiments. It will also be appreciated that the slot may be provided in a different panel to the front panel, or a different panel to the door 22.

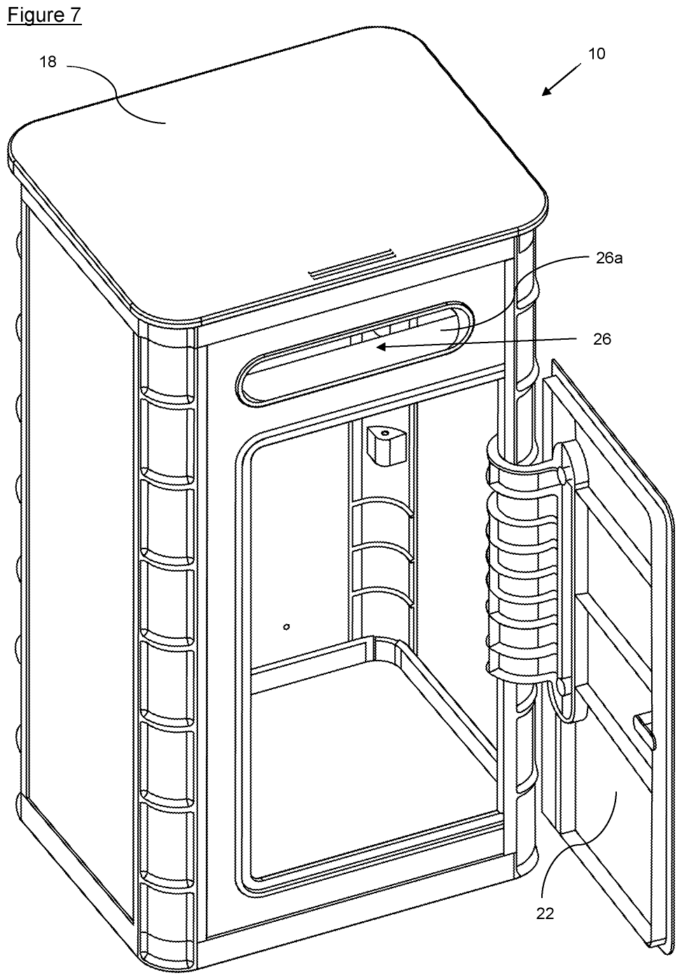

A ledge 26a is provided internally of the slot 26, best seen in FIG. 7.

The parcel storage chamber 13 inside the housing is substantially empty (prior to use). That is, there are no parts of the storage box which occupy a significant volume within the interior of the chamber, leaving room for parcels to be received. A base 13a of the chamber 13 includes a cushioning or impact-absorbing material such as foam, particularly EPS foam. The base 13a of the chamber 13 can be an inside face of the base 14 in some embodiments, or the cushioning/impact-absorbing material may be provided on the inside of the housing base 14 in other embodiments.

In respect of the hinged lid 18, an underside 18a of the lid is shown in FIG. 2. The underside includes a planar area. A machine-readable code or label can be provided on the underside of the lid 18. For example, in some embodiments a barcode or QR code may be provided. This may provide a unique identifier which can be associated with the parcel storage box, and the location or address it is present at.

The lid 18 also includes magnets, indicated generally at 18b. The magnets 18b are located along an underside of the front of the lid 18 in this embodiment. That is, the along a side of the lid 18 which is distal to the hinge. However, it will be appreciated that the magnets may be provided in other parts of the lid 18 in other embodiments.

The magnets 18b are over-moulded into the plastic of the lid 18 in this embodiment.

Corresponding magnets 28 or magnetisable material, such as iron or steel, is provided in a corresponding position on a rim 30 where the lid 18 meets the housing 12. The lid 18 therefore has a magnetic latch in this embodiment.

It will be appreciated that magnets 18b may in some embodiments instead be a magnetic or magnetisable material, such as iron or steel, where corresponding magnets are provided in the relevant part(s) of the housing.

In this embodiment, the rim 30 defines a parcel ‘entrance’, indicated generally at 32, that is an entry point for a parcel to enter the chamber 13. The entrance 32 in this embodiment has dimensions of approximately 34 cm×26 cm. However, it will be appreciated that the size of the parcel entrance may vary between embodiments and the parcel entrance should large enough to accept at least some parcels typically handled by postal services or couriers. The entrance 32 should be able to accept parcels which have a minimum dimension of 8 cm on each Cartesian axis, for example.

A barrier is provided across the entrance. The barrier including four triangular members 34 in this embodiment. The barrier members are made of a rubber material in this embodiment.

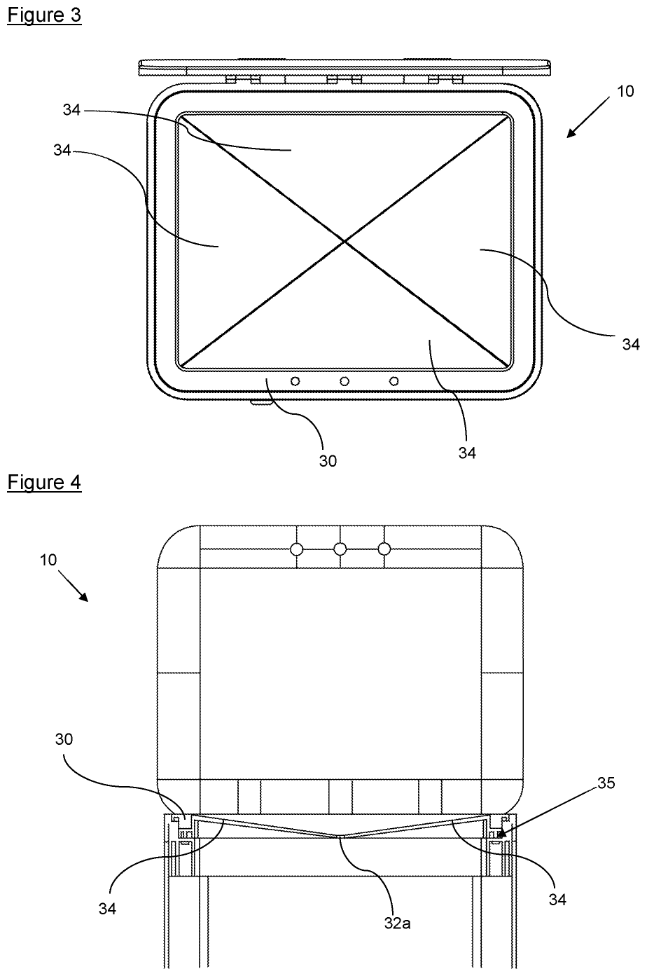

The parcel entrance is substantially rectangular in this embodiment, and there are two triangular shapes of barrier member 34 to provide a barrier which substantially covers the whole parcel entrance 32. Both shapes of barrier member have an isosceles shape when viewed from above (see FIG. 3), with opposing members 34 being substantially the same size and shape. It will be appreciated that other barrier member shapes may be used in other embodiments.

A cross-section of the barrier is shown in FIG. 4. Each barrier member 34 is secured in place by fixing means 35, such as screws or bolts. The rim 30 is secured over the barrier members 34 around the periphery of the parcel entrance 32. The arrangement is described with respect to FIGS. 11-12.

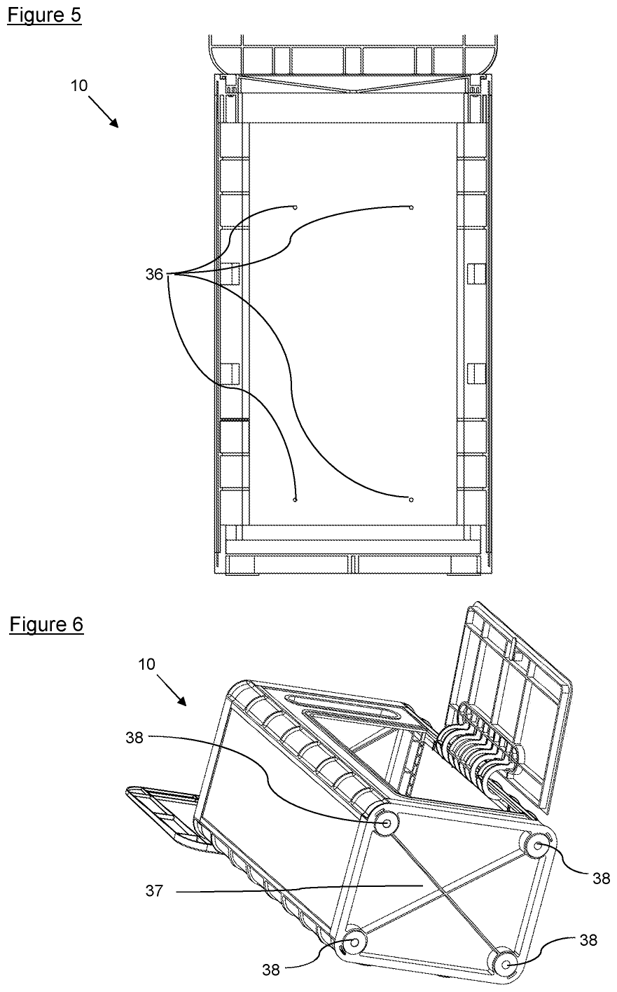

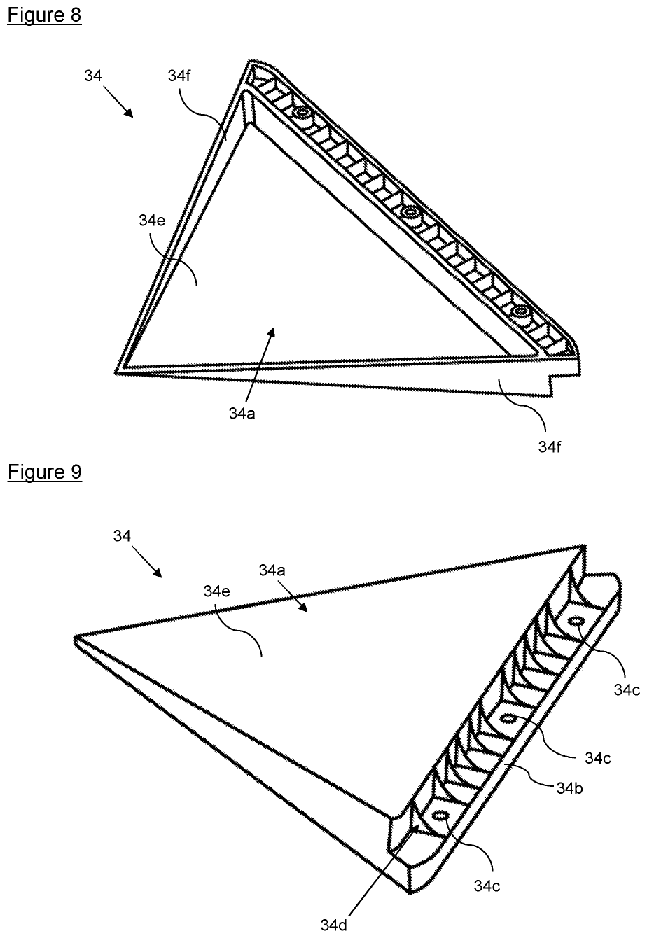

Each barrier member 34 slopes downwardly from the peripheral edge of the parcel entrance 32 towards a middle 32a of the parcel entrance 32. The slope is relative to the horizontal. The slope is relatively shallow, e.g. less than about 20 degrees in this embodiment. The sloped nature of the barrier members is also seen in FIG. 5. The barrier members are discussed further with respect to FIGS. 8 and 9.

Fixing holes 36 (see FIG. 5) are provided through the rear panel 16 of the housing 12. The fixing holes 36 are provided at the corners of an imaginary rectangle inset within the panel 16. Suitable screws or bolts, for example, may be used to secure the box 10 to a wall or other structure adjacent to the box 10.

Fixing apertures 38 are also provided in the base 14 of the box 10. Screws or other fixing means can be used to secure the base 14 to a structure below the box 10. For example, the box 10 may be secured to one or more paving slabs or bricks, or to an artificial floor (e.g. concrete), or any other suitable ground surface or secure object underneath the box 10.

The base 14 also includes several rubber panels (one of which is indicated at 37).

Referring to FIGS. 8 and 9, one of the barrier members 34 is shown in more detail in isolation from the box 10. The member 34 includes a triangular body indicated generally at 34a and a flange 34b joined to the body 34a. The flange 34b is the part that is securable to the housing 12, and includes a plurality of holes 34c for receiving fixings.

The flange 34b is approximately half as thick as the body 34a. A plurality of ribs indicated generally at 34d extend from a flange-facing side wall of the body 34a to a top of the flange 34b. The ribs are substantially triangular in this embodiment.

The triangular body 34a tapers in thickness in a direction away from the flange 34b. Each barrier member may be considered to have a wedge-shaped portion. The body 34a includes a top wall 34e and two side walls 34f, which each meet the flange-facing side wall. The side walls 34f are substantially orthogonal to the top wall 34e.

FIG. 10 shows the barrier members 34 are shown connected to an isolated upper part 17 of the housing 12, without the rim 30, during assembly from a kit for example. The upper part of the housing 12 is designed to connect to tops of the corner members 20 via snap-fit connections with each corner member 20. The upper part 17 also includes sidewalls which depend between the corners for fitting against or next to the side panels 16. The front sidewall of the upper part 17 is shaped to provide an upper end part of the parcel exit in this embodiment.

One of the snap-fit connections is shown in FIG. 10, prior to the corner member 20 and upper part 17 of the housing 12 being connected together. A downward-facing latch 39a with a sloped face is provided on the upper part of the housing 12. A corresponding recess or receiving portion 39b is provided on the top of the corner member 20. It will be appreciated that the complementary connections may be on the opposite components in other embodiments, and that the exact structures used to provide the snap-fit or push-fit connections may vary between embodiments within the scope of the claims.

The rim 30 is seen in isolation in FIG. 11, and relative to the upper part 17 of the housing 12 in FIG. 12. The fixings 35 are secured in the underside of the rim 30, passing through the upper part 17 of the housing 12 and the barrier members 34 respectively. Whilst only four screws 35 are depicted, it will be appreciated that twelve screws are intended to be used in this embodiment (three per barrier member 34).

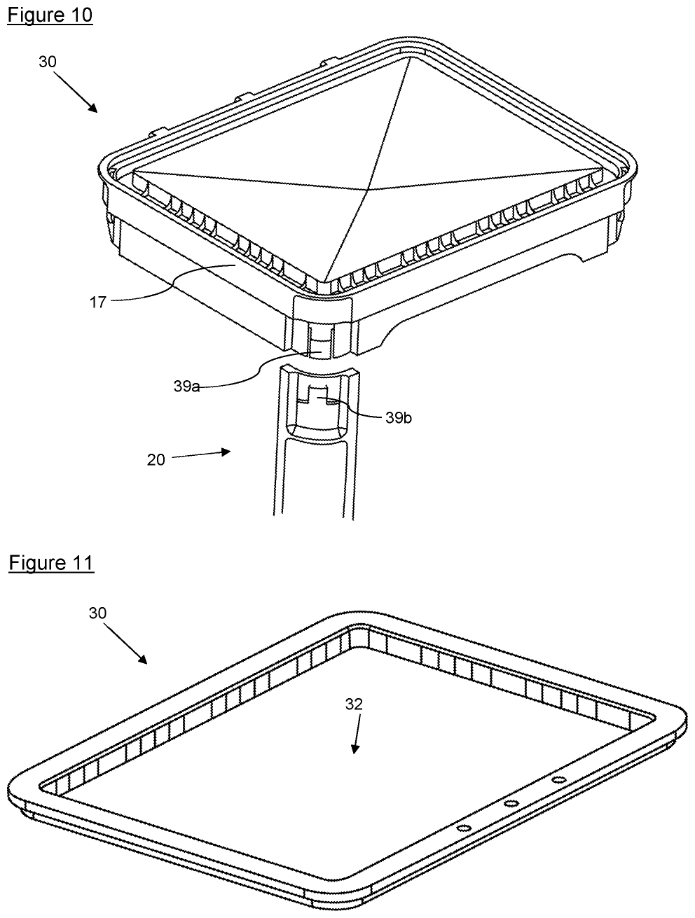

The rear side of the box 10 is depicted in FIG. 13. Four wall brackets 40 are provided on the rear panel 16. The brackets 40 are aligned with the apertures 36 through the panel 16. Fixings can pass through the holes 36 and brackets 40 to hold the box 10 in position relative to a wall, for example. The brackets 40 may abut the wall or other structure once secured, protecting the fixings from weathering. The brackets 40 are made of rubber in this embodiment.

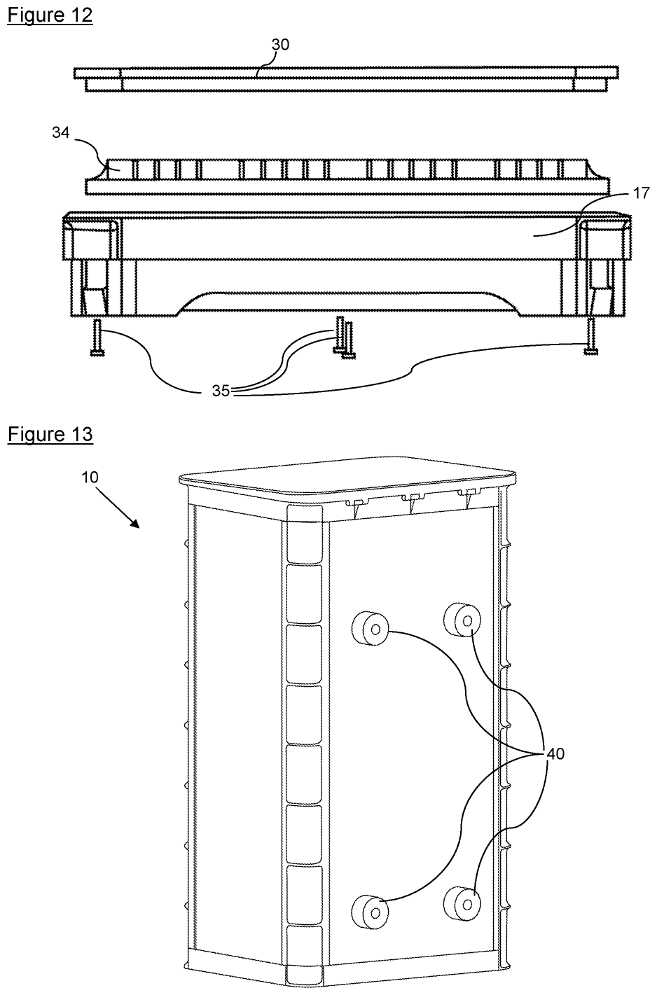

Use of the parcel storage box will now be described with respect to FIGS. 14 and 15.

In FIG. 14, a parcel 100 is being deposited into the chamber 13 via the parcel entrance 32. The lid 18 is open and the parcel 100 is being pushed against the barrier, deforming the members 34′ into the chamber 13 to the extent required to accept the parcel 100. The barrier members 34 deform into the chamber 13 comparatively easily.

Once the top of the parcel 100 has passed the apices of the barrier members 34, it lands on the foam at the base of the chamber 13. The barrier members 34 return to substantially their original positions across the parcel entrance 32.

In FIG. 15, the parcel 100 is in the chamber 13 and parcel retrieval is being attempted via the parcel entrance 32. The person attempting to retrieve the parcel is not shown, but it will be appreciated that they have reached in through the (unlocked) parcel entrance in an attempt to lift the parcel 100 out of the parcel entrance 32, past the barrier 34.

During the attempted retrieval, the top of the parcel 100 impinges against the undersides of the barrier members. The barrier members 34″ are shown to deform slightly outwardly, resulting in a curved top face for each barrier. However, the structure of each barrier member substantially resists deformation in that direction, i.e. away from the chamber 13. The resistance tends to be higher for larger parcels due to the point at which the parcel engages the barrier members.

The parcel storage box therefore provides a convenient means for parcel drop-off, and introduces a substantial barrier to opportunistic parcel theft. When provided in kit form as a flat-pack arrangement, it is efficient to pack and transport which is logistically advantageous.

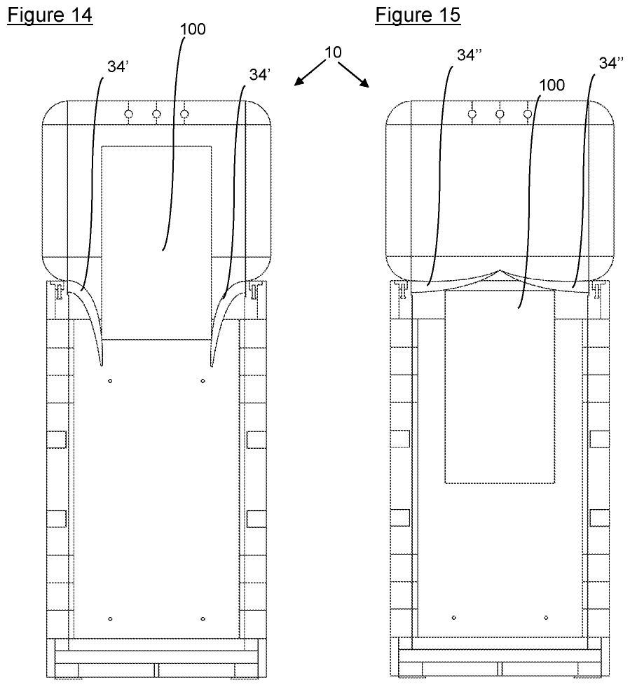

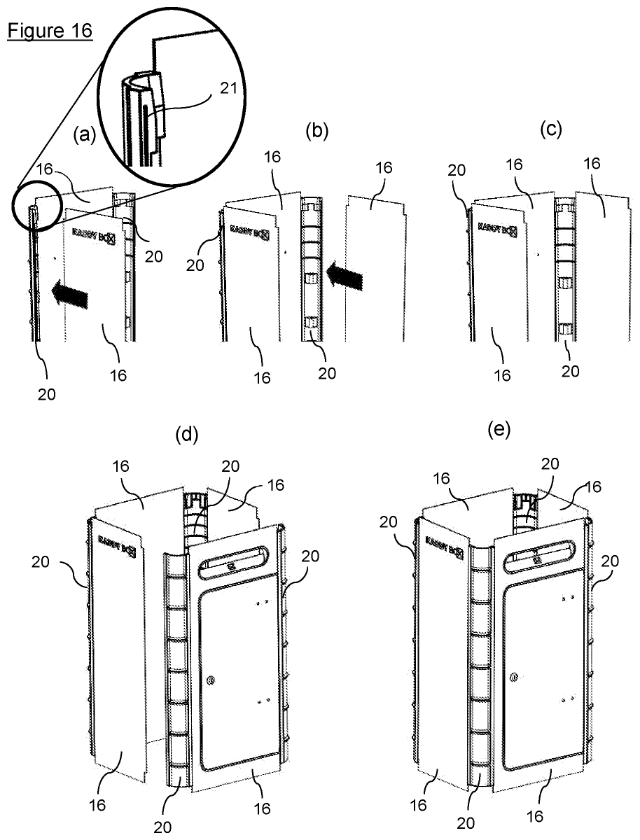

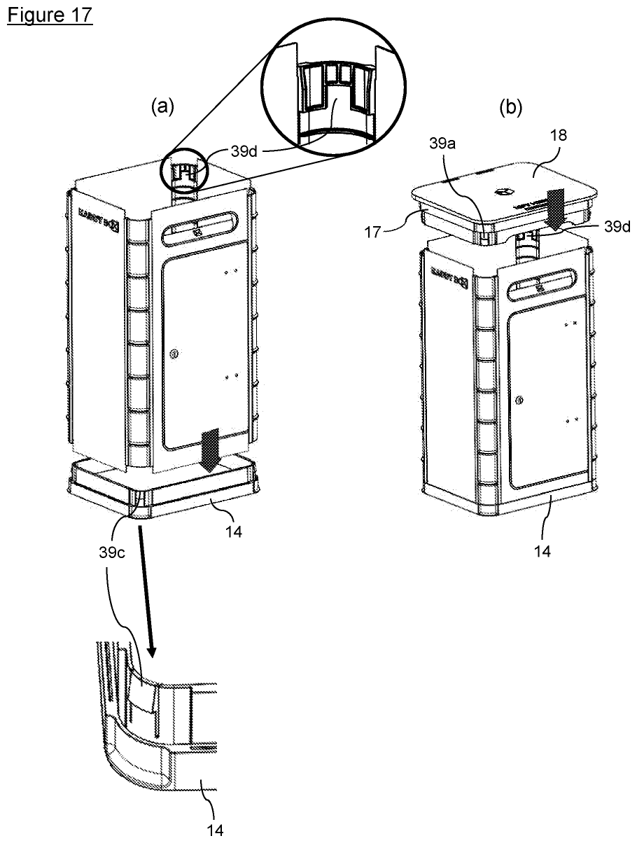

FIGS. 16a to 17b show assembly or construction of another embodiment of another parcel storage box from a kit. The features of the kit are similar to those of the above, except as now described. In particular, the snap-fit connections in the box assembled from the kit are different, as discussed below.

The box is constructed by connecting the side panels 16, corner members 20, base 14 and top including the lid 18 and upper part 17 of the housing 12 together via snap-fit connections.

As shown mainly in FIG. 16a and its inset view, each side of the corner members 20 includes a slot 21 that runs along substantially the full length of the corner member 20. A lateral side edge of each side panel 16 is slotted into the corresponding slot 21 in a lateral side of a corner member 20, providing a tab and slot connection. The side panel to corner member connection or join may be friction-fit or snap-fit, for example.

Note that the size and shape of the slot 21 substantially matches the length and thickness of the side edge of the panel. It will be appreciated that the slot 21 may not run along with the full length of the corner member in some embodiments, as long as its shape is able to receive a portion of the side panel.

To assemble the storage box, first and second corner members 20 are connected to either side of the rear panel 16. A first side panel 16 is then connected to one of the corner members 20 already attached to the rear panel 16 (see FIG. 16a) and a second side panel 16 is slotted into the other corner member 20 already attached to the real panel 16 (see FIGS. 16b and 16c).

In this embodiment, the other two corner members 20 are provided already attached to the front panel 16, e.g. by permanent attachment means. However, in other embodiments, the corner members 20 can be releasably attached to the front panel 16 or may be attached by snap-fit connections, for example.

The corner members 20 attached to the front panel are connected to or slotted onto the available lateral side edges of the side panels 16 (see FIG. 16d), thereby forming an assembly of side panels 16 and corner members 20 (see FIG. 16e). The assembly is open-ended at the top and base at this stage of assembly.

The base 14 includes a sidewall which extends upwards from the base 14, as shown in FIG. 17a. An upward facing latch 39c with a sloped face is provided at each corner of the side wall of the base 14. The detent of the latch faces outwardly from the side wall on the base 14 in this embodiment. A corresponding recess or receiving portion (of the same type shown at 39d at the upper end of the corner member 20) is provided at the lower end of each corner member 20. The connection is preferably not visible from the exterior of the box, so the recess/receiving portion is provided on a surface facing towards an interior of the parcel storage box in this embodiment.

Similar to the embodiment shown in FIG. 10, FIG. 17b shows a downward facing latch 39a with a sloped face. A latch 39a is provided at each corner of the side wall depending from the upper part 17 of the housing 12. The detect of the latch 39a faces outwardly from the side wall of the lid 17 in this embodiment. A corresponding recess or receiving portion of the type shown at 39d is located at the upper end of the corner member 20. The connection is preferably not visible from the exterior of the box, so the corresponding recess or receiving portion 39d is provided on a surface which faces towards an interior of the parcel storage box in this embodiment.

To progress assembly of the box, a lower end of the assembly of side panels 16 is engaged with the base 14 by connection of the latches 39c with the recesses or receiving portions at the lower ends of the corner members, as shown in FIG. 17a. The top 17 is then engaged with the upper end of the assembly of side panels 16 by connection of the latches 39a with the recesses or receiving portions 39d at the upper ends of the corner members 20, as shown in FIG. 17b. Note that an impact pad or foam can be provided in the base prior to or after assembly of the base with the panels. The impact pad or foam may be removable so that it can be replaced if worn out or damaged, for example.

Whilst some embodiments of the invention have been described above, it will be appreciated that other embodiments of the invention are envisaged within the scope of the claims.

For example, the box 10 may include a sensor or sensors in some embodiments. A load sensor may be used to detect when a parcel or parcels have been delivered. A motion sensor and/or vibration sensor may be used for the same reason, or to detect unauthorised access. One or more cameras may be provided in some embodiments, for monitoring the outside and/or inside of the box 10. Still images and/or video may be recorded, and may stored locally or remotely on a data storage device.

A transmitter may be provided as a communication means, connected to the sensor(s) for signalling the sensor output to a remote electronic device, such as a smartphone or tablet (or another portable device). A processor and other suitable electronics may be provided as needed.

The door may be locked against opening by an electronic lock in some embodiments. The electronic lock may prevent the door from opening until disengaged. A keypad or other input means may be provided to allow (temporary) disengagement of the lock to allow parcel retrieval. For example, if a QR code (or other machine-readable device/image) on the storage box is scanned by a delivery person, then an unlock code may be manually or automatically input to unlock the electronic lock and allow the parcel to be retrieved. This may include a signal sent directly to the storage box.

It will be appreciated that other forms or shapes of storage box may be provided depending on the intended installation position and use case. For example, a series of side-by-side storage boxes may be provided for installation in a communal postal area, such as in an elongate housing which has multiple parcel storage chambers.

In other embodiments, a parcel delivery network may include a plurality of parcel storage boxes. Some of the parcel storage boxes are provided at specific postal addresses (which may be delivery addresses for a subset of parcels to be delivered). That is, some of the boxes are at terminal locations for one or more parcels on a delivery route. A parcel delivery route involving only parcels destined for addresses at which parcel storage boxes according to the present invention are provided allows for more efficient delivery.

Some of the parcel storage boxes may be provided at commercial locations (e.g. retail shops or similar), and may be located in a geographically central location relative to the area across which parcels are intended to be delivered using the network. Some of the parcel storage boxes may be located at other locations, which may not have a dedicated postal address. These boxes may be considered as waystations at intermediate delivery locations, at which parcels can be dropped off and picked up by various people involved in delivery of the parcels.

Optimal use of the parcel storage boxes to reduce overall delivery times and fuel/electrical energy use, as well as minimise carbon footprint, in delivering a large number of parcels can be optimised using a suitable parcel delivery planning system.

The embodiments described above are provided by way of example only, and various changes and modifications will be apparent to persons skilled in the art without departing from the scope of the present invention as defined by the appended claims.

1-14. (canceled)

15. A parcel storage box for storing one or more parcels, the box comprising
a housing comprising a base, one or more sides and a top, at least some of which are connected together by snap-fit connections, and including a parcel storage chamber,
a parcel entrance in the housing for allowing a parcel having dimensions of at least 8 cm×8 cm×8 cm to be introduced into the parcel storage chamber, and
a lockable parcel exit in the housing for allowing the parcel to be retrieved from the parcel storage chamber,
in which one or more barrier members are connected to the housing and form a barrier across at least part of the parcel entrance to in use substantially obstruct parcel removal through the parcel entrance,
the one or more barrier members being moveable or deformable into the parcel storage chamber for admitting a parcel into the parcel storage chamber, and the barrier members being configured to substantially re-form the barrier across the parcel entrance after admitting a parcel.

16. A parcel storage box as claimed in claim 15, including one, two or all three of:
the parcel entrance is provided in an upper portion or top side of the parcel storage box;
the parcel exit is in a side of the housing and includes a door and a key-operated lock or an electronic lock; and
a slot is provided in the housing for accepting a letter or thin parcel into the parcel storage chamber.

17. A parcel storage box as claimed in claim 15, in which there are a plurality of barrier members, or four barrier members arranged across the parcel entrance, which are moveable or deformable into the parcel storage chamber without hinging at a perimeter of the parcel entrance, and one or both of:
the plurality of barrier members are made of rubber or flexible polymer or configured to substantially resist movement or deformation in a direction away from the parcel storage chamber; and
one or more tethers are connected to the one or more barrier members for resisting upward deformation or movement of the barrier members.

18. A parcel storage box as claimed in claim 15, in which each barrier member is triangular and/or wedge-shaped, having a base side arranged along a side of the parcel entrance and an apex arranged in a central region of the parcel entrance.

19. A parcel storage box as claimed in claim 15, in which the barrier is substantially planar and includes a plurality of barrier members or four barrier members arranged across the parcel entrance, the barrier members being arranged in a common horizontal plane, and the barrier members substantially cover the whole area of the parcel entrance.

20. A parcel storage box as claimed in claim 15, in which a hinged cover or lid is provided over the parcel entrance and the one or more barrier members.

21. A parcel storage box as claimed in claim 15, in which the base has snap-fit connections to the one or more sides, and/or the top has snap-fit connections to the one or more sides.

22. A parcel storage box as claimed in claim 15, in which a base wall of the parcel storage chamber comprises a cushioning material or impact pad or foam or EPS foam.

23. A parcel storage box as claimed in claim 15, including one or both of:
the housing includes one or more floor-fixing connection points; and
a side of the housing includes one or more wall-fixing connection points.

24. A parcel storage box as claimed in claim 15, including a sensor for detecting one or more parcels delivered into the parcel storage chamber, and communication means which is configured to send a signal to an electronic device such as a smartphone for notifying a user when the sensor detects parcel delivery.

25. A parcel storage box as claimed in claim 24, including one or both of:
the sensor includes a load sensor or weight sensor which is configured to detect a load on a base wall of the parcel storage chamber, an alarm is connected to the load sensor or weight sensor, and in use the alarm is primed for activation when the load sensor or weight sensor detects a parcel has been placed in the chamber; and
an output from the sensor is used to trigger a notification to an electronic device.

26. A parcel storage box as claimed in claim 15, in which an electronic lock is provided to lock the parcel exit, and input means or a keypad is provided for unlocking the electronic lock for allowing a parcel to be removed from the parcel storage chamber.

27. A parcel storage box as claimed in claim 26, in which a machine-readable label or code or QR code is provided on the housing or parcel exit for scanning by an electronic device of a delivery person, and in which the machine-readable label or code corresponds to or is usable to generate an input code for use in unlocking the electronic lock.

28. A parcel storage box as claimed in claim 15, including a camera or camera system configured to record and/or transmit one or more images of a region in front of the parcel storage box.

29. A parcel delivery system for delivering a plurality of parcels to a plurality of locations, the system comprising a plurality of parcel storage boxes, each parcel storage box being as claimed in claim 15, in which
the plurality of parcel storage boxes are at a plurality of addresses, each parcel in the plurality of parcels to be delivered is addressed to an address which is one of the plurality of addresses, and a delivery route for delivering the plurality of parcels includes substantially only delivery stops at addresses which are comprised in the plurality of addresses; or
the plurality of parcel storage boxes are distributed over a geographical area, in which, in a first subset of the parcel storage boxes, each parcel storage box is a way station at an intermediary location for receiving one or more parcels in transit for delivery at one or more subsequent destinations, and in a second subset of the parcel storage boxes, each parcel storage box is located at a given destination for at least one of the parcels being delivered.

30. A parcel storage box for storing one or more parcels, the box comprising
a housing including a parcel storage chamber,
a parcel entrance in the housing for allowing a parcel having dimensions of at least 8 cm×8 cm×8 cm to be introduced into the parcel storage chamber, and
a lockable parcel exit in the housing for allowing the parcel to be retrieved from the parcel storage chamber,
in which one or more barrier members are connected to the housing and form a barrier across at least part of the parcel entrance to in use substantially obstruct parcel removal through the parcel entrance,
in which each barrier member is triangular and/or wedge-shaped, having a base side arranged along a side of the parcel entrance and an apex arranged in a central region of the parcel entrance,
in which each barrier member has a triangular body and a flange joined to the triangular body, the flange being securable to the housing and including a plurality of holes for receiving fixings,
in which the triangular body includes a top wall and two side walls, which each meet a flange-facing side wall of the triangular body, the side walls being substantially orthogonal to the top wall, in which the triangular body tapers in thickness in a direction away from the flange,
the one or more barrier members being moveable or deformable into the parcel storage chamber for admitting a parcel into the parcel storage chamber, and the barrier members being configured to substantially re-form the barrier across the parcel entrance after admitting a parcel.

31. A kit for construction into a parcel storage box for storing one or more parcels, the kit comprising
a base, one or more side panels or sides for connection to the base, and a top for connection to the one or more side panels or sides, which are configured for assembly into a housing that includes a parcel storage chamber and a parcel entrance for allowing a parcel having dimensions of at least 8 cm×8 cm×8 cm to be introduced into the parcel storage chamber, and
a lockable parcel exit in or connectable to one of the side panels or sides for allowing the parcel to be retrieved from the parcel storage chamber,
one or more barrier members which are connectable to the housing to form a barrier across at least part of the parcel entrance to in use substantially obstruct parcel removal through the parcel entrance,
when connected to the housing, some or all of the barrier members being moveable or deformable into the parcel storage chamber for admitting a parcel into the parcel storage chamber, and the barrier members being configured to substantially re-form the barrier across the parcel entrance after admitting a parcel, and
one or both of the following:
at least some of the base, the side panels or sides, and the top are connectable together by snap-fit connections; and
each barrier member is triangular and/or wedge-shaped, having a base side arranged along a side of the parcel entrance and an apex arranged in a central region of the parcel entrance, each barrier member having a triangular body and a flange joined to the triangular body, the flange being securable to the housing and including a plurality of holes for receiving fixings, the triangular body including a top wall and two side walls, which each meet a flange-facing side wall of the triangular body, the side walls being substantially orthogonal to the top wall, in which the triangular body tapers in thickness in a direction away from the flange.

32. A kit as claimed in claim 31, in which the base has snap-fit connections to the one or more side panels or sides, and/or the top has snap-fit connections to the one or more side panels or sides.

33. A kit as claimed in claim 31, in which the one or more barrier members are, when connected to the housing, in a substantially horizontal plane of the parcel entrance relative to the one or more side panels of the housing.

34. A kit as claimed in claim 31, whose elements are provided in a flat-pack arrangement.
